(19) United States
(12) Patent Application Publication
(10) Pub. No.: US 2015/0215462 A1
(43) Pub. Date: Jul. 30, 2015

(54) CALL CENTER UPSELLING ON A USER PROFILE

(71) Applicant: THOMSON LICENSING, Issy de Moulineaux (FR)

(72) Inventor: Admire SIMBARASI, Valley Village, CA (US)

(21) Appl. No.: 14/168,072

(22) Filed: Jan. 30, 2014

(51) Int. Cl. H04M 3/523; H04M 3/487; H04M 3/42; G06Q 30/02

(52) U.S. Cl. CPC H04M 3/5232; G06Q 30/0251; H04M 3/4878; H04M 3/42059

(57) ABSTRACT

A method and apparatus for upselling at a customer call center are described including receiving a call from a customer, identifying the customer, retrieving a profile for the customer including information regarding content viewed by the customer, providing the customer with information related to the content viewed by the customer, presenting the customer with a plurality of offers, receiving an indication of offers selected by the customer populating a content consumption service with information regarding any offers selected by the customer, transmitting an electronic message to the customer regarding the any selected offers and connecting the customer with a representative at the customer call center.

### FIELD OF THE INVENTION

The present invention is directed to call center operations and, in particular, to providing a user with offers and trivia when a call center linked to a media service is called. The offers/trivia offered are linked to the content that the user consumed using the media service.

### BACKGROUND OF THE INVENTION

A user is presented with audible-based content that is relevant to the user while the user is waiting to talk with a call center operator.

### SUMMARY OF THE INVENTION

The present invention is directed to call center operations and, in particular, to providing a user with offers and trivia when a call center linked to a media (content) service is called. The offers/trivia offered are linked to the content that the user consumed using the media service. The media (content) service is typically provided by a media (content) consumption server that is implemented on the media (content) service providers server.

A method and apparatus for upselling at a customer call center are described including receiving a call from a customer, identifying the customer, retrieving a profile for the customer including information regarding content viewed by the customer, providing the customer with information related to the content viewed by the customer, presenting the customer with a plurality of offers, receiving an indication of offers selected by the customer populating a content consumption service with information regarding any offers selected by the customer, transmitting an electronic message to the customer regarding the any selected offers and connecting the customer with a representative at the customer call center.

### BRIEF DESCRIPTION OF THE DRAWINGS

The present invention is best understood from the following detailed description when read in conjunction with the accompanying drawings. The drawings include the following figures briefly described below:

FIG. 1 is a flowchart of an exemplary embodiment of the present invention.

FIG. 2 is a schematic diagram of an exemplary embodiment of the present invention.

### DETAILED DESCRIPTION OF THE PREFERRED EMBODIMENTS

The present invention provides material that is targeted to a user, when the user calls a service such as a help desk or other type of telephone-based customer service. A help desk or telephone-based customer service may include any sort of online chat implementation. While the user is waiting to talk with a customer service representative, the present invention identifies the caller using a lookup technique such as caller ID whereby the caller's profile is retrieved.

In response to the identification of the caller (user), pre-recorded voice-synthesized generated content is presented to the user (caller). The content presented to the caller is selected based on the caller's profile. The profile information is generated in response to how the caller uses a media consumption service such as M-Go, Netflix, Amazon Prime and the like. Specifically, the user's consumption of media, such as what movies and television programs (content) that the user views, affects what information is in the generated caller's profile.

A first automated message can be presented to the user (caller), while waiting for an operator (customer service representative). The first automated message can be related to content that the user viewed (watched) using the media consumption service. For example, the message can be about the movie “Batman Begins” if the user watched that movie or the message can be about the television program “Mad Men” if the user viewed (watched, displayed, rendered) that program through the media consumption service.

From the first automated message, the user is presented with a menu which has different options about different data about the viewed content. For example, option 1 may be “learn to buy the same clothes as the actors of Mad Men”. Option 2 may be “learn about the history of New York and how to get there”. Option 3 may be “learn about additional content (movies, television programs etc.) that start John Hamm”. Once a user selects an option, the user can receive the selected information (data). For example, if the user selects option 2, the user receives information (data) about New York City. AT the end of the provided information, the method and apparatus of the present invention presents an offer to the user related to New York City. Such as offer may be “You can save $X if you want to fly to New York City if you want to fly to New York City on American Airlines” or “Would you like to learn about the Mad Men tour in New York City. If you do, you can get 25% off the price of the tour.” Offers should be related to the viewed content (media).

The telephonic system of the customer call center of the media (content) consumption service of the present invention, then provides the user with the ability to learn more about the offer by sending (transmitting) an electronic message (text message, email, web link, etc.) that has more information about the offer. Alternatively, the offer populated on the media consumption service, so that the media service itself can be used to upsell the user. For example, if the user indicated an interest in the New York City travel offer, the telephonic system of the customer call center of the media (content) consumption service of the present invention could provide videos about New York City, which further link to travel websites. Other examples of such offers of media (content) are possible in accordance with the principles of the present invention. For example, other types of content can be offered to the user based on the user's response to the telephone prompts of the integrated voice response system of the customer call center of the media (content) consumption service of the present invention. After such offers are presented to the user, the media (content) consumption service may receive a commission on any offers that the user selects.

If an operator is available after such offers are presented, the user can then speak with the operator (customer service representative). Otherwise, additional offer and trivia information is provided to the user until the user requests that the presentation of such offers stops (ceases). In an alternative embodiment, the operator (customer service representative) follows up with the offer(s).

In a further alternative embodiment, a user can be linked to talking with an operator more quickly if the user either listens to the offers or purchases a presented offer. For example, the wait time may be reduced from 5 minutes to 1 minute if the user listens to an offer.

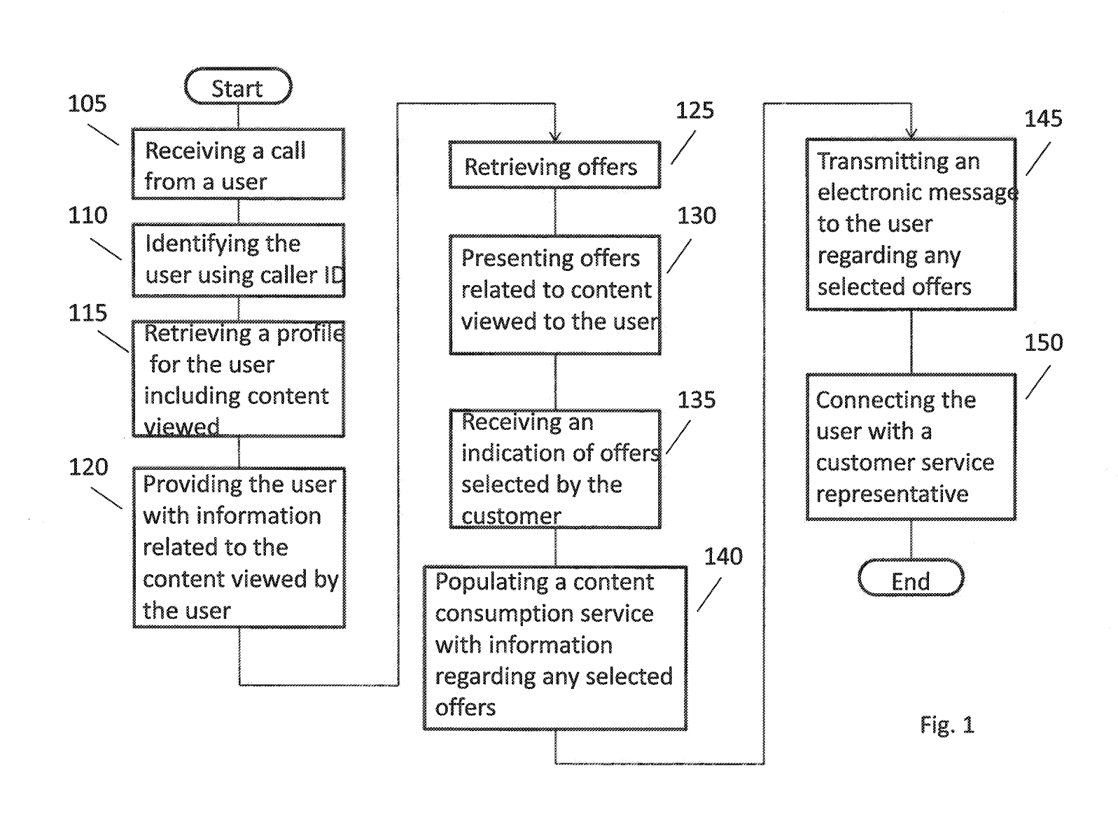

Referring now to FIG. 1, which is a flowchart of an exemplary embodiment of the present invention. At 105, a call is received at the customer call center from a user (subscriber, caller, customer). At 110 the user that calls into the call center is identified based on caller ID information. At 115, user profile information is retrieved based on the user's (customer's) caller ID and includes media (content) consumed by the user. At 120, the user is presented with (provided with) audible information related to the media (content) that the user has consumed (viewed, rendered, displayed). At 125, offers are retrieved from the storage system. At 130 the user is audibly provided (presented) with different offers for additional media (content) or merchandise (e.g., clothes) or services (e.g., airline flights, tours). At 135, an indication of any offers selected by the customer is received. At 140, the media (content) consumption service is populated with information regarding offer(s) accepted (selected) by the user. At 145 an electronic message (e.g., text message, email, web link, etc.) is sent (transmitted, forwarded) to the user with the offer. At 150 the user is connected to (with) an operator (customer service representative) to handle the original call for service.

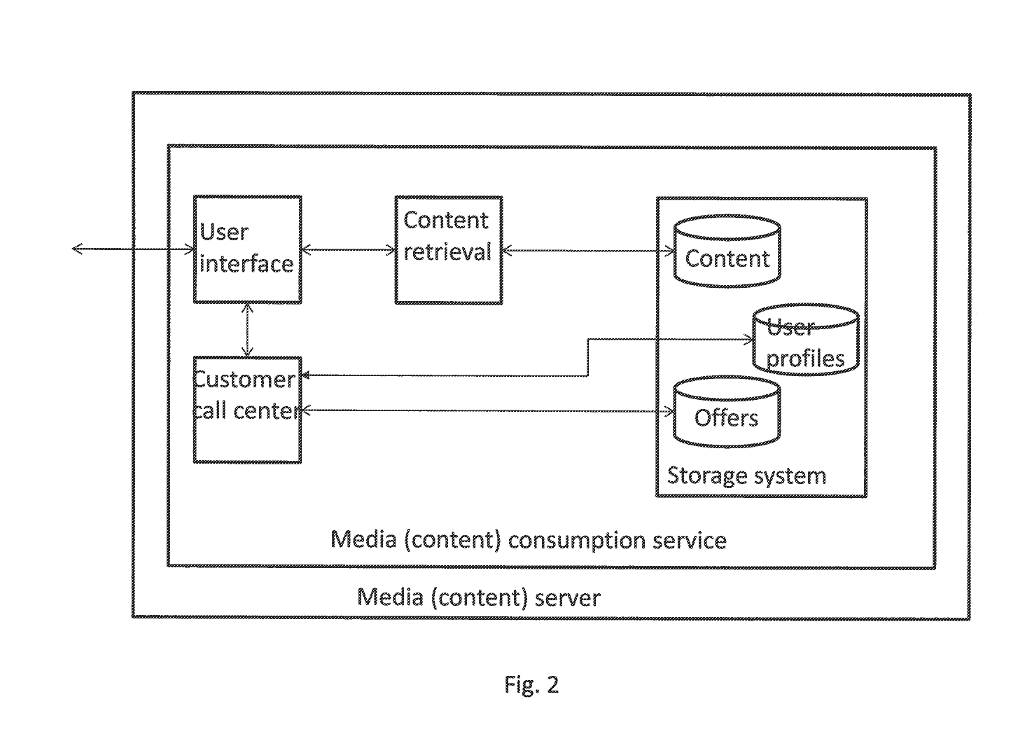

FIG. 2 is a schematic diagram of an exemplary embodiment of the present invention. The media (content) server is implemented in the content (media) provider's site. Within the content (media) server are one or more processors for providing customers with content and access to a customer call center. The processor shown is denoted as they media (content) consumption service. All services and processors are not shown. For example the accounting/billing services or processors are not shown. The media (content) consumption service of the present invention includes a user interface to receive requests online or telephonically or by text messages. There may actually be multiple user interfaces segregated by interface type (online, telephonically, etc.). The user interface is bi-directionally connected to the user as well as being bi-directionally connected to a content retrieval system, which accesses content on a storage system. The storage system may be segregated by type of data. For example, the data may be segregated into content, user profiles and offers. The storage system may be a single large “disc farm” or a plurality of smaller storage systems. The user interface is also bi-directionally connected to a customer call center, which is bi-directionally connected to both the “user profiles” data and the “offers” data.

In accordance with the principles of the present invention, a customer (user, caller) calls the media (content) consumption center to obtain a service. The incoming customer call is routed to the customer call center. The user is identified by the user's caller ID. The customer call center then retrieves the user's profile based on the user's (customer's) caller ID and includes media (content) consumed by the user. The customer call center then retrieves offers related to the content from the “offers” data in the storage system(s). The offers are presented to the user (caller). The user selects which offers the user wants to receive. If the user selects an offer to purchase then an electronic message (e.g., text message, email, web link, etc.) is sent (transmitted) to the user. The user is then connected to a customer service representative.

It is to be understood that the present invention may be implemented in various forms of hardware, software, firmware, special purpose processors, or a combination thereof. Special purpose processors may include application specific integrated circuits (ASICs), reduced instruction set computers (RISCs) and/or field programmable gate arrays (FPGAs). Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method for upselling at a customer call center, said method comprising:
receiving a call from a customer;
identifying said customer;
retrieving a profile for said customer including information regarding content viewed by said customer;
providing said customer with information related to said content viewed by said customer;
presenting said customer with a plurality of offers;
receiving an indication of offers selected by said customer;
populating a content consumption service with information regarding any offers selected by said customer;
transmitting an electronic message to said customer regarding said any selected offers; and
connecting said customer with a representative at said customer call center.

2. The method according to claim 1, wherein said electronic message is one of an email, a text message and a web link.

3. The method according to claim 1, wherein said offers are for additional content.

4. The method according to claim 1, wherein said offers are for services.

5. The method according to claim 1, wherein said offers are for merchandise.

6. The method according to claim 1, wherein said information related to said content viewed by said customer is presented audibly.

7. The method according to claim 1, wherein said plurality of selections of offers are presented audibly.

8. The method according to claim 1, wherein said customer is identified using caller ID.

9. An apparatus for upselling at a customer call center, comprising:
a user interface for bi-directional communication with a user, said user interface also including means for identifying said customer upon receipt of a call from said customer, said user interface also including means for receiving an indication of offers selected by said customer;
a storage system; and
said customer call center including means for retrieving a profile of said customer from said storage system, said customer call center also including means for providing said customer with information related to said content viewed by said customer, said customer call center also including means for presenting said customer with a plurality of offers, said customer call center also including means for populating a content consumption service with information regarding any offers selected by said customer, said customer call center also including means for transmitting an electronic message to said customer regarding said any selected offers, said customer call center also including connecting said customer with a representative at said customer call center.

10. The apparatus according to claim 9, wherein said providing and presenting are audible.

11. The apparatus according to claim 9, wherein said customer is identified using caller ID.
